(19) United States
(12) Patent Application Publication
(10) Pub. No.: US 2010/0169003 A1
(43) Pub. Date: Jul. 1, 2010

(54) LOCATION DATA PROCESSING APPARATUS AND METHOD OF IMPORTING LOCATION INFORMATION

(76) Inventor: Sander Van Der Meer, Amsterdam (NL)

Correspondence Address: HARNESS, DICKEY & PIERCE, P.L.C., P.O. BOX 8910, RESTON, VA, 20195, US

(21) Appl. No.: 12/451,848

(22) PCT Filed: Jun. 4, 2008
(86) PCT No.: PCT/EP2008/004614

§ 371 Date: Mar. 3, 2010

(30) Foreign Application Priority Data
Jun. 4, 2007 (US) 609941868

(51) Int. Cl. G06F 17/30; G06F 9/44; G06F 15/16; G01C 21/00; G06F 3/01

(52) U.S. Cl. 701/207; 719/328; 709/203; 715/760; 707/736; 707/E17.044

(57) ABSTRACT

A location data processing apparatus includes a data enrichment module arranged to receive, when in use, content generated in response to a content request. The data enrichment module is arranged to embed location importation data in the content prior to presentation thereof. In at least one embodiment, the location importation data is organized in accordance with a data structure definition.

### FIELD OF THE INVENTION

The present invention relates to a location information importation apparatus of the type that, for example, receives data and enriches the received data. The present invention also relates to a method of importing location information of the type that, for example, receives a request for content and services the request for content with enriched data.

### BACKGROUND OF THE INVENTION

Portable computing devices, for example Portable Navigation Devices (PNDs) that include GPS (Global Positioning System) signal reception and processing functionality are well known and are widely employed as in-car or other vehicle navigation systems.

In general terms, a modem PND comprises a processor, memory (at least one of volatile and non-volatile, and commonly both), and map data stored within said memory. The processor and memory cooperate to provide an execution environment in which a software operating system may be established, and additionally it is commonplace for one or more additional software programs to be provided to enable the functionality of the PND to be controlled, and to provide various other functions.

Typically these devices further comprise one or more input interfaces that allow a user to interact with and control the device, and one or more output interfaces by means of which information may be relayed to the user. Illustrative examples of output interfaces include a visual display and a speaker for audible output. Illustrative examples of input interfaces include one or more physical buttons to control on/off operation or other features of the device (which buttons need not necessarily be on the device itself but could be on a steering wheel if the device is built into a vehicle), and a microphone for detecting user speech. In one particular arrangement, the output interface display may be configured as a touch sensitive display (by means of a touch sensitive overlay or otherwise) additionally to provide an input interface by means of which a user can operate the device by touch.

Devices of this type will also often include one or more physical connector interfaces by means of which power and optionally data signals can be transmitted to and received from the device, and optionally one or more wireless transmitters/receivers to allow communication over cellular telecommunications and other signal and data networks, for example Bluetooth, Wi-Fi, Wi-Max, GSM, UMTS and the like.

PNDs of this type also include a GPS antenna by means of which satellite-broadcast signals, including location data, can be received and subsequently processed to determine a current location of the device.

The PND may also include electronic gyroscopes and accelerometers which produce signals that can be processed to determine the current angular and linear acceleration, and in turn, and in conjunction with location information derived from the GPS signal, velocity and relative displacement of the device and thus the vehicle in which it is mounted. Typically, such features are most commonly provided in in-vehicle navigation systems, but may also be provided in PNDs if it is expedient to do so.

The utility of such PNDs is manifested primarily in their ability to determine a route between a first location (typically a start or current location) and a second location (typically a destination). These locations can be input by a user of the device, by any of a wide variety of different methods, for example by postcode, street name and house number, previously stored “well known” destinations (such as famous locations, municipal locations (such as sports grounds or swimming baths) or other points of interest), and favourite or recently visited destinations.

Typically, the PND is enabled by software for computing a “best” or “optimum” route between the start and destination address locations from the map data. A “best” or “optimum” route is determined on the basis of predetermined criteria and need not necessarily be the fastest or shortest route. The selection of the route along which to guide the driver can be very sophisticated, and the selected route may take into account existing, predicted and dynamically and/or wirelessly received traffic and road information, historical information about road speeds, and the driver's own preferences for the factors determining road choice (for example the driver may specify that the route should not include motorways or toll roads).

In addition, the device may continually monitor road and traffic conditions, and offer to or choose to change the route over which the remainder of the journey is to be made due to changed conditions. Real time traffic monitoring systems, based on various technologies (e.g. mobile phone data exchanges, fixed cameras, GPS fleet tracking) are being used to identify traffic delays and to feed the information into notification systems.

PNDs of this type may typically be mounted on the dashboard or windscreen of a vehicle, but may also be formed as part of an on-board computer of the vehicle radio or indeed as part of the control system of the vehicle itself. The navigation device may also be part of a hand-held system, such as a PDA (Portable Digital Assistant), a media player, a mobile phone or the like, and in these cases, the normal functionality of the hand-held system is extended by means of the installation of software on the device to perform both route calculation and navigation along a calculated route.

Route planning and navigation functionality may also be provided by a desktop or mobile computing resource running appropriate software. For example, the Royal Automobile Club (RAC) provides an on-line route planning and navigation facility at http://www.rac.co.uk, which facility allows a user to enter a start point and a destination whereupon the server with which the user's computing resource is communicating calculates a route (aspects of which may be user specified), generates a map, and generates a set of exhaustive navigation instructions for guiding the user from the selected start point to the selected destination. The facility also provides for pseudo three-dimensional rendering of a calculated route, and route preview functionality which simulates a user travelling along the route and thereby provides the user with a preview of the calculated route.

In the context of a PND, once a route has been calculated, the user interacts with the navigation device to select the desired calculated route, optionally from a list of proposed routes. Optionally, the user may intervene in, or guide the route selection process, for example by specifying that certain routes, roads, locations or criteria are to be avoided or are mandatory for a particular journey. The route calculation aspect of the PND forms one primary function, and navigation along such a route is another primary function.

During navigation along a calculated route, it is usual for such PNDs to provide visual and/or audible instructions to guide the user along a chosen route to the end of that route, i.e. the desired destination. It is also usual for PNDs to display map information on-screen during the navigation, such information regularly being updated on-screen so that the map information displayed is representative of the current location of the device, and thus of the user or user's vehicle if the device is being used for in-vehicle navigation.

An icon displayed on-screen typically denotes the current device location, and is centred with the map information of current and surrounding roads in the vicinity of the current device location and other map features also being displayed. Additionally, navigation information may be displayed, optionally in a status bar above, below or to one side of the displayed map information, examples of navigation information include a distance to the next deviation from the current road required to be taken by the user, the nature of that deviation possibly being represented by a further icon suggestive of the particular type of deviation, for example a left or right turn. The navigation function also determines the content, duration and timing of audible instructions by means of which the user can be guided along the route. As can be appreciated a simple instruction such as “turn left in 100 m” requires significant processing and analysis. As previously mentioned, user interaction with the device may be by a touch screen, or additionally or alternately by steering column mounted remote control, by voice activation or by any other suitable method.

A further important function provided by the device is automatic route re-calculation in the event that: a user deviates from the previously calculated route during navigation (either by accident or intentionally); real-time traffic conditions dictate that an alternative route would be more expedient and the device is suitably enabled to recognize such conditions automatically, or if a user actively causes the device to perform route re-calculation for any reason.

It is also known to allow a route to be calculated with user defined criteria; for example, the user may prefer a scenic route to be calculated by the device, or may wish to avoid any roads on which traffic congestion is likely, expected or currently prevailing. The device software would then calculate various routes and weigh more favourably those that include along their route the highest number of points of interest (known as POIs) tagged as being for example of scenic beauty, or, using stored information indicative of prevailing traffic conditions on particular roads, order the calculated routes in terms of a level of likely congestion or delay on account thereof. Other POI-based and traffic information-based route calculation and navigation criteria are also possible.

Although the route calculation and navigation functions are fundamental to the overall utility of PNDs, it is possible to use the device purely for information display, or “free-driving”, in which only map information relevant to the current device location is displayed, and in which no route has been calculated and no navigation is currently being performed by the device. Such a mode of operation is often applicable when the user already knows the route along which it is desired to travel and does not require navigation assistance.

Devices of the type described above, for example the ONE model manufactured and supplied by TomTom International B.V., provide a reliable means for enabling users to navigate from one position to another. Such devices are of great utility when the user is not familiar with the route to the destination to which they are navigating.

As mentioned above, previously stored “well known” destinations or other points of interest, or favourite or recently visited destinations can be used in relation to navigation using the PND. In this respect, the PND typically comprises a database of points of interest that accompanies the map data stored in the memory or other storage device of the PND. The points of interest data offered by manufacturers of PNDs or map vendors is virtually indistinguishable from each other from the perspective of a consumer. Furthermore, the points of interest data usually available to PNDs is typically out of date, because a hysteresis exists between compilation of the points of interest data by a map vendor and eventual release and publication for use in PNDs. The delay is particularly attributable to a desire to time the release of the points of interest data with map releases. Additionally, the points of interest data is usually incomplete and insufficiently comprehensive for the needs of most users of PNDs. Furthermore, searching of the points of interest data is quite limited. Indeed, a user of the PND is typically only able to search the points of interest data according to one criterion or category, for example “restaurants”. It is not possible to “drill down” through the points of interest data in order to specify further detail of interest, for example “Italian restaurants”, and hence limit the results further in order to reduce the workload of the user of the PND when reviewing the results the search. Whilst third party sets of points of interest have been made available, installation of a third party set of points of interest into the PND is relatively cumbersome for the user to perform. Also, the third party sets of points of interest are not designed for scalability.

### SUMMARY OF THE INVENTION

According to a first aspect of the present invention, there is provided a location data processing apparatus comprising: a data enrichment module arranged to receive, when in use, content generated in response to a content request; wherein the data enrichment module is arranged to embed location importation data in the content prior to presentation thereof, the location importation data being organized in accordance with a data structure definition.

The data enrichment module may be arranged to analyze the content and identify candidate location information therein, the data enrichment module being further arranged to generate the location importation data from the candidate location information.

The data enrichment module may be arranged to extract data from the candidate location information, the data corresponding to a number of fields of the data structure definition, and organize the extracted data in accordance with the data structure definition.

At least part of the location importation data may be encoded as a Uniform Resource Indicator (URI). At least part of the location importation data may be encoded as a Universal Resource Locator (URL).

The data structure definition may conform to an Application Programming Interface (API) of a server. The Application Programming Interface may relate to a navigation apparatus or a device management application for the navigation apparatus.

The data enrichment module may be arranged to embed an object in the content associated with the location importation data, the object providing a visual indication of an existence of location information importable into a navigation apparatus and associated with a geographic location shown in the content.

The location importation data may be compatible with an import process of the device management application and/or a navigation apparatus. The import process may be provided for direct importation of at least part of the location importation data.

The location importation data may comprise a request in accordance with a request/response communications protocol.

According to a second aspect of the present invention, there is provided a client terminal apparatus comprising: a processing resource arranged to support the location data processing apparatus as set forth above in relation to the first aspect of the invention; and a communications interface for communicating the content request to a content server; wherein the processing resource is arranged to support a user interface for receiving information relating to the content request.

The information relating to the content request may comprise a first search term. The information relating to the content request may comprise a second search term. The information relating to the content request may comprise a third search term. The information relating to the content request may comprise a plurality of search terms, including the first, second and/or third search terms.

The apparatus may further comprise: a browser application supported by the user interface for providing a data collection interface for collecting the information relating to the content request; wherein the browser application is arranged to present the content received as modified by the data enrichment module.

The data collection interface may be a web page. The browser may be arranged to present the content received by the data enrichment module as another web page, for example a search results web page.

The data enrichment module may be a browser plug-in.

The data enrichment module may be arranged to receive identification information via an input device, the identification information identifying at least part of the content received and relating to a geographic location, the data enrichment module being arranged to generate the location importation data in respect of the part of the content received and in response to the provision of the identification information.

The input device may be part of a touch-screen or may be a computer mouse.

The apparatus may further comprise: a device management application for managing an externally connectable navigation device, the device management application being arranged to provide, when in use, a data collection interface for collecting the information relating to the content request; wherein the device management application is arranged to present the content received as modified by the data enrichment module.

The device management application may be arranged to determine whether a navigation device is coupled to the client terminal apparatus.

The device management application may be arranged to import at least part of the location importation data into the navigation device in response to the navigation device being detected as coupled to the client terminal apparatus.

The importation of the at least part of the location importation data may be in response to a user input. The user input may be an indication to show a geographic location corresponding to the at least part of the location importation data on a map. The user input may be to store the at least part of the location importation data as a point of interest or set of points of interest. The user input may be to store the at least part of the location importation data as a favourite location.

The device management application may be arranged to queue the at least part of the location importation data for subsequent importation into the navigation device in response to the navigation device being detected as disconnected from the client terminal apparatus.

The apparatus may further comprise: a navigation application of a navigation apparatus, the navigation application being arranged to provide, when in use, a data collection interface for collecting the information relating to the content request; wherein the navigation application is arranged to present the content received as modified by the data enrichment module.

According to a third aspect of the invention, there is provided a navigation device comprising the client terminal apparatus as set forth above in relation to the second aspect of the invention.

The processing resource may be arranged, via the user interface, to present a plurality of geographic locations and to permit a user to select more than one of the plurality of geographic locations to provide an indication of a set of points of interest.

The processing resource may be arranged to permit a selection of a name of the set of points of interest. The processing resource may be arranged to permit selection of a graphical image for the set of points of interest and/or a geographic location of the set of points of interest. The processing resource may be arranged to provide, via the user interface, a facility for user selection of all of the plurality of geographic locations by a single user action. The single user action may be selection of a “select all” type check box.

The location importation data may identify a server for converting the location importation data into an importable format organized in accordance with another data structure definition that can be used by the client terminal apparatus for importation.

The importable format may be used by a navigation apparatus for direct importation of at least part of the location importation data into the navigation apparatus. The importable format may be used by the device management application for direct importation of at least part of the location importation data into the navigation device.

The processing resource may be arranged to communicate the selected more than one of the plurality of geographic locations to the server for processing and subsequent receipt of the location importation data corresponding to the set of points of interest.

Location importation data may be arranged so that a browser application opens a launch page in response to selection of the location importation data.

The processing resource may be arranged to communicate a request to a server in response to user-selection of the location importation data, the request being indicative of a request for wireless communication of information corresponding to at least part of the location importation data from the server to a navigation apparatus for importation into the navigation apparatus.

According to a fourth aspect of the present invention, there is provided a method of importing location information into a navigation apparatus, the method comprising: communicating a request for content from a client terminal to a server; accessing and processing data in order to service the request for content, the content comprising candidate location information corresponding to a geographic location; generating location importation data relating to the candidate location information, the location data being organised in accordance with a data structure definition; and embedding the location importation data in the content.

According to a fifth aspect of the present invention, there is provided a method of executing an electronic transaction in relation to provision of location data for a navigation apparatus, the method comprising: partnering with a content provider in order to serve a request for content; using a data structure definition to provide the location data in a format for importation into a navigation device, the location data relating to a geographic location identified in the content; and recording a request for the location data; and allocating a share of revenue made by the content provider from a third party in respect of serving at least part of the content.

The revenue shared may relate to advertising revenue associated with the request for content.

According to a sixth aspect of the present invention, there is provided a computer program element comprising computer program code means to make a computer execute the method as set forth above in relation to the fourth or fifth aspects of the invention.

The computer program element may be embodied on a computer readable medium.

Advantages of these embodiments are set out hereafter, and further details and features of each of these embodiments are defined in the accompanying dependent claims and elsewhere in the following detailed description.

It is thus possible to provide an apparatus, system and method that permits access to a very complete and up-to-date database of location information and, in particular, from trusted sources of information. Indeed, improved accessibility to location information enables a user to obtain relevant, correct and rich information content from the database of location information. Furthermore, the data obtained is more up-to-date than data mined from existing points of interest databases stored locally by PNDs. Also, the user has access to location information that has a higher standard and richness of content as compared with existing points of interest information currently stored by PNDs. The ability to use existing searching facilities, both engines and databases, in order to obtain location information results in improved relevance of the location information obtained. In this respect, the search engines can be used to enable the user to specify, with greater detail, the types of locations of interest. The access to available sophisticated and flexible search facilities allows a user to freely type any desired search criterion in order to specify a genre or category of location of interest and any number of sub-genres or sub-categories. Consequently, any personal needs of the user to find a location in any territory can be achieved.

Additionally, it is possible to use this ability to obtain highly focussed location information in order to form sets of location information, thereby enabling personalised sets of location information, for example points of interest, to be created and used in a PND.

An advantageous degree of accessibility to the location information is also provided to enable a user to obtain location information from a computing apparatus, for example a Personal Computer (PC) at home, work or elsewhere, for example at a so-called Internet Café or some other third party location where a computing apparatus is present.

It is also possible to provide enhanced ease and speed of setting destinations and/or waypoints when planning a route. The location information obtained can be seamlessly integrated into the PND for storage and subsequent use in relation to navigation or other purposes. In this respect, installation of the location information obtained is relatively quick and can be achieved in a user-friendly manner, thereby reducing the workload of the user, particularly when in a vehicle and hence improve user safety. Furthermore, the location information obtained and installed on the PND is compatible with existing navigation features of the PND and so can be used to assist in providing the user with an improved navigation experience that involves less driver and/or user workload, for example due to reduced time to set a route using the PND.

The apparatus, system and method also enables reliable and secure provision of location information, namely the user has confidence that the location information has been obtained from a known and reliable source of information, for example a known web search provider, and hence risk of provision of erroneous information from a malicious source is minimized.

Due to the compatibility of the apparatus, system and method with most popular web browser technology, the user is also provided with enhanced choice. It is further possible to provide improved flexibility in respect of obtaining the location information in that it is possible to adapt easily to changes to data structure definitions that may subsequently be imposed by content providers, for example search result providers. The location information provided is also scalable and the technique employed to obtain and install the location information offers a degree of backwards compatibility.

From a commercial perspective, it is also possible to provide an, optionally free, service that enables the PND manufacturer to study location information requested by users in order to be able to provide improved services in terms of type and quality of content provided. Implementation of the facility is relatively low-cost and also provides an opportunity for revenue sharing, for example of advertisement revenue, thereby enabling the provision of the facility by the PND manufacturer at no cost to the owner and/or user of the PND. The PND manufacturer is thus provided with a competitive advantage in a highly competitive marketplace. Furthermore, brand exposure of the PND manufacturer on the Internet is improved and brand loyalty is improved as well as the ability to create tie-ins between desirable brands and that of the PND manufacturer. Furthermore, when the accompanying software for use on a computer is used to obtain and install the location information, the consumer is also presented with an opportunity to acquire other products and services that may be of interest and benefit to the user.

### BRIEF DESCRIPTION OF THE DRAWINGS

At least one embodiment of the invention will now be described, by way of example only, with reference to the accompanying drawings, in which:

FIG. 1 is a schematic illustration of electronic components of a navigation device;

FIG. 2 is a schematic representation of an architectural stack employed by the navigation device of FIG. 1;

FIG. 3 is a schematic diagram of a communications system for communication between a client terminal and a first server and a second server;

FIG. 4 is a flow diagram of methods of location information importation constituting a respective number of embodiments of the invention;

FIGS. 5 to 10 are screen shots from a client terminal in accordance with a method of FIG. 4 and constituting an embodiment of the invention;

FIG. 11 is a screen shot of a view generated by a client terminal as used in another embodiment of the invention;

FIG. 12 is a screen shot of a view generated by a device management application in accordance with a further embodiment of the invention;

FIG. 13 is a flow diagram of a methods used by the device management application of FIG. 12;

FIGS. 14 to 18 are further screen shots of views generated by the device management application of FIG. 12;

FIGS. 19 and 20 are screen shots of views displayed by the device management application in accordance with a yet further embodiment of FIG. 13;

FIG. 21 is a screen shot of a view displayed by the device management application in accordance with another embodiment; and

FIG. 22 is a screen shot of a view displayed by the client terminal of a browser in accordance with yet another embodiment of the invention.

### DETAILED DESCRIPTION OF PREFERRED EMBODIMENTS

Throughout the following description identical reference numerals will be used to identify like parts.

Embodiments of the present invention will now be described with particular reference to a PND and/or a device management application therefor. It should be remembered, however, that the teachings of the present invention are not limited to PNDs and device management applications therefor but are instead universally applicable to any type of processing device that is configured to execute navigation software in a portable or mobile manner so as to provide route planning and navigation functionality. It follows therefore that in the context of the present application, a navigation device is intended to include (without limitation) any type of route planning and navigation device, irrespective of whether that device is embodied as a PND, a vehicle such as an automobile, or indeed a portable computing resource, for example a portable personal computer (PC), a mobile telephone or a Personal Digital Assistant (PDA) executing route planning and navigation software.

It will also be apparent from the following that the teachings of the present invention even have utility in circumstances where a user is not seeking instructions on how to navigate from one point to another, but merely wishes to be provided with a view of a given location. In such circumstances, the “destination” location selected by the user need not have a corresponding start location from which the user wishes to start navigating, and as a consequence references herein to the “destination” location or indeed to a “destination” view should not be interpreted to mean that the generation of a route is essential, that travelling to the “destination” must occur, or indeed that the presence of a destination requires the designation of a corresponding start location.

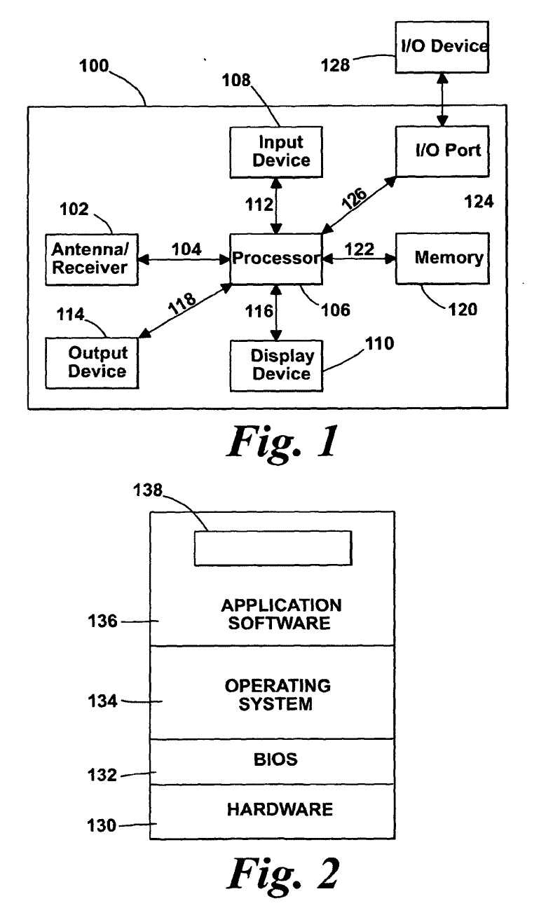

Referring to FIG. 1, a navigation device 100 is located within a housing (not shown). The navigation device 100 comprises or is coupled to a GPS receiver device 102 via a connection 104, wherein the GPS receiver device 102 can be, for example, a GPS antenna/receiver. It should be understood that the antenna and receiver designated by reference numeral 102 are combined schematically for illustration, but that the antenna and receiver may be separately located components, and that the antenna may be a GPS patch antenna or helical antenna for example.

The navigation device 100 includes a processing resource comprising, for example, a processor 106, the processor 106 being coupled to an input device 108 and a display device, for example a display screen 110. Although reference is made here to the input device 108 in the singular, the skilled person should appreciate that the input device 108 represents any number of input devices, including a keyboard device, voice input device, touch panel and/or any other known input device utilised to input information. Likewise, the display screen 110 can include any type of display screen for example a Liquid Crystal Display (LCD).

In one arrangement, one aspect of the input device 108, the touch panel, and the display screen 110 are integrated so as to provide an integrated input and display device, including a touchpad or touchscreen input to enable both input of information (via direct input, menu selection, etc.) and display of information through the touch panel screen so that a user need only touch a portion of the display screen 110 to select one of a plurality of display choices or to activate one of a plurality of virtual or “soft” buttons. In this respect, the processor 106 supports a Graphical User Interface (GUI) that operates in conjunction with the touchscreen.

In the navigation device 100, the processor 106 is operatively connected to and capable of receiving input information from input device 108 via a connection 112, and operatively connected to at least one of the display screen 110 and an output device 114, for example an audible output device (e.g. a loudspeaker), via respective output connections 116, 118. As the output device 114 can produce audible information for a user of the navigation device 100, it is should equally be understood that the input device 108 can include a microphone and software for receiving input voice commands as well. Further, the navigation device 100 can also include any additional input device 108 and/or any additional output device, for example audio input/output devices.

The processor 106 is operatively connected to memory 120 via connection 122 and is further arranged to receive/send information from/to input/output (I/O) port 124 via connection 126, wherein the I/O port 124 is connectible to an I/O device 128 external to the navigation device 100.

It will, of course, be understood by one of ordinary skill in the art that the electronic units schematically shown in FIG. 1 are powered by one or more power sources (not shown) in a conventional manner. As will also be understood by one of ordinary skill in the art, different configurations of the units shown in FIG. 1 are contemplated. For example, the components shown in FIG. 1 may be in communication with one another via wired and/or wireless connections and the like. Thus, the navigation device 100 described herein can be a portable or handheld navigation device 100.

The external I/O device 128 may include, but is not limited to, an external listening device, such as an earpiece for example. The connection to I/O device 128 can further be a wired or wireless connection to any other external device, for example a car stereo unit for hands-free operation and/or for voice activated operation, for connection to an earpiece or headphones, and/or for connection to a mobile telephone. The mobile telephone connection can be used to establish a data connection between the navigation device 100 and the Internet or any other network for example, and/or to establish a connection to a server via the Internet or some other network for example.

The navigation device 100 is capable of establishing a data session, if required, with network hardware of a “mobile” or telecommunications network via a mobile device (not shown), for example the mobile telephone described above, a PDA and/or any device with mobile telephone technology, in order to establish a digital connection, for example a digital connection via known Bluetooth technology. Thereafter, through its network service provider, the mobile device can establish a network connection (through the Internet for example) with the server (not shown in FIG. 1). As such, a “mobile” network connection can be established between the navigation device 100 (which can be, and often times is, mobile as it travels alone and/or in a vehicle) and the server to provide a “real-time” or at least very “up to date” gateway for information.

The establishing of the network connection between the mobile device (via the service provider) and another device such as the server, using the Internet for example, can be done in a known manner. In this respect, any number of appropriate data communications protocols can be employed, for example the TCP/IP layered protocol. Furthermore, the mobile device can utilize any number of communication standards such as CDMA2000, GSM, IEEE 802.11 a/b/c/g/n, etc. Hence, it can be seen that the Internet connection may be utilised, which can be achieved via data connection, via a mobile telephone or mobile telephone technology within the navigation device 100 for example.

For telephone settings, a Bluetooth enabled navigation device may be used to work correctly with the ever changing spectrum of mobile phone models, manufacturers, etc., model/manufacturer specific settings may be stored on the navigation device 100 for example. The data stored for this information can be updated.

As mentioned above, and although not shown, the navigation device 100 may, of course, include its own mobile telephone technology within the navigation device 100 itself (including an antenna for example, or optionally using the pre-existing internal antenna of the navigation device 100). The mobile telephone technology within the navigation device 100 can include internal components, and/or can include an insertable card (e.g. Subscriber Identity Module (SIM) card), complete with necessary mobile telephone technology and/or an antenna for example. As such, mobile telephone technology within the navigation device 100 can similarly establish a network connection between the navigation device 100 and the server, via the Internet for example, in a manner similar to that of any mobile device.

It should be noted that the block diagram of the navigation device 100 described above is not inclusive of all components of the navigation device 100, but is only representative of many example components.

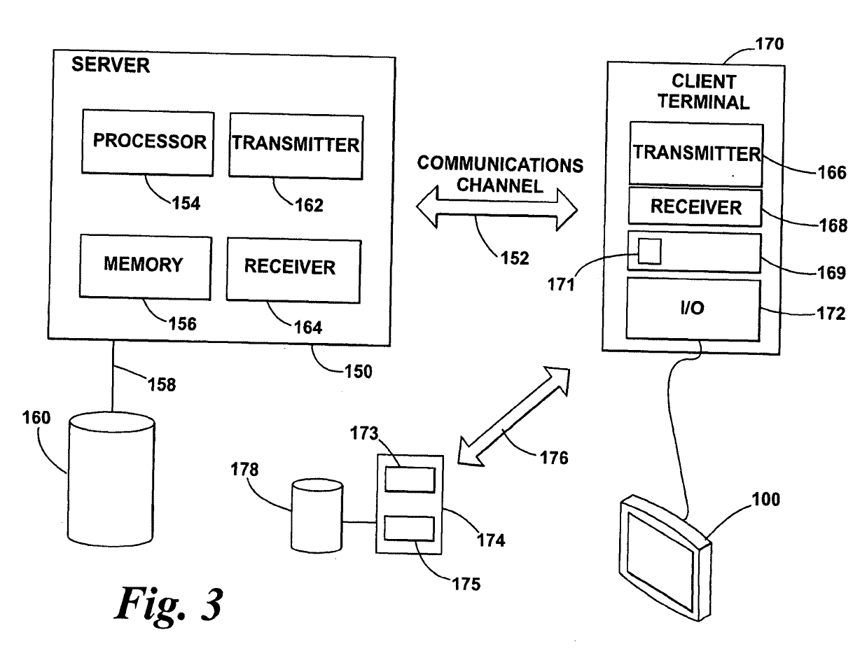

Turning to FIG. 2, the processor 106 and memory 120 cooperate to support a BIOS (Basic Input/Output System) 132 that functions as an interface between functional hardware components 130 of the navigation device 100 and the software executed by the navigation device 100. The processor 106 then loads an operating system 134 from the memory 120, which provides an environment in which application software 136 (implementing some or all of the above described route planning and navigation functionality) can run. The application software 136 provides an operational environment including the GUI that supports core functions of the navigation device 100, for example map viewing, route planning, navigation functions and any other functions associated therewith. In this respect, part of the application software 136 comprises a data importation module 138.

Referring to FIG. 3, a client terminal 170 is depicted as being in communication with the server 150 via a generic communications channel 152 that can be implemented by any of a number of different arrangements. The communication channel 152 generically represents the propagating medium or path that connects the client terminal 170 and the server 150. The server 150 and the client terminal 170 can communicate when a connection via the communications channel 152 is established between the server 150 and the client terminal 170 (noting that such a connection can be a data connection via mobile device, a direct connection via the internet, etc.).

The communication channel 152 is not limited to a particular communication technology. Additionally, the communication channel 152 is not limited to a single communication technology; that is, the channel 152 may include several communication links that use a variety of technologies. For example, the communication channel 152 can provide a path for electrical, optical, and/or other electromagnetic communications, etc. As such, the communication channel 152 includes, but is not limited to, one or a combination of the following: electric circuits, electrical conductors such as wires and coaxial cables, fibre optic cables, converters, radio-frequency (RF) waves, the atmosphere, free space, etc. Furthermore, the communication channel 152 can include intermediate devices such as routers, repeaters, buffers, transmitters, and receivers, for example.

The communication signals transmitted through the communication channel 152 include, but are not limited to, signals as may be required or desired for given communication technology. For example, the signals may be adapted to be used in cellular communication technology such as Time Division Multiple Access (TDMA), Frequency Division Multiple Access (FDMA), Code Division Multiple Access (CDMA), Global System for Mobile Communications (GSM), etc. Both digital and analogue signals can be transmitted through the communication channel 152. These signals may be modulated, encrypted and/or compressed signals as may be desirable for the communication technology.

The server 150 includes, in addition to other components which may not be illustrated, a processor 154 operatively connected to a memory 156 and further operatively connected, via a wired or wireless connection 158, to a mass data storage device 160. In this example, the mass storage device 160 contains a store of search-related data and, optionally, map information, and can again be a separate device from the server 150 or can be incorporated into the server 150. The processor 154 is further operatively connected to transmitter 162 and receiver 164, to transmit and receive information to and from the client terminal 170 via the communications channel 152. The signals sent and received may include data, communication, and/or other propagated signals. The transmitter 162 and receiver 164 may be selected or designed according to the communications requirement and communication technology used in the communication design for the client terminal 170. Further, it should be noted that the functions of transmitter 162 and receiver 164 may be combined into a single transceiver.

Software stored in server memory 156 provides instructions for the processor 154 and allows the server 150 to provide services to the client terminal 170.

As mentioned above, the client terminal 170 can be arranged to communicate with the server 150 through communications channel 152, using transmitter 166 and receiver 168 to send and receive signals and/or data through the communications channel 152, noting that these devices can further be used to communicate with devices other than server 150. Further, the transmitter 166 and receiver 168 are selected or designed according to communication requirements and communication technology used in the communication design for the client terminal 170 and the functions of the transmitter 166 and receiver 168 may be combined into a single transceiver.

In this embodiment, the navigation device 100 is connectable to the client terminal 170 via a cable and an input/output port 172 of the client terminal 170, for example a Universal Serial Bus (USB) port. The client terminal 170 is, in this example, a PC, for example a desktop or laptop, supporting an operating system, such as a version of the Windows™ operating system distributed by Microsoft Corporation. However, the skilled person should appreciate that any other suitable operating system can be employed, for example OS X available from Apple, Inc. As PCs are commonplace, the hardware configuration of the PC 170 will not be described in further detail herein for the sake of conciseness and clarity of description. However, the skilled person will appreciate that the PC comprises a processing resource 169 for supporting, in some embodiments, a data enrichment module 171. The PC also comprises peripherals, for example input and/or output devices, such as a keyboard (not shown), a display (not shown) and optionally a mouse (also not shown).

In this example, the server 150 is a content server that supports a search engine. However, the client terminal 170 is also capable of communicating with another server 174 via another communications channel 176 of a same or similar type to the communications channel 152. The another server 174 is, in this example, a location importation data delivery server 174 that supports a transaction recordal database 178. In a like manner to the processor 150, the server 174 comprises a communications interface 173 and a processing resource 175.

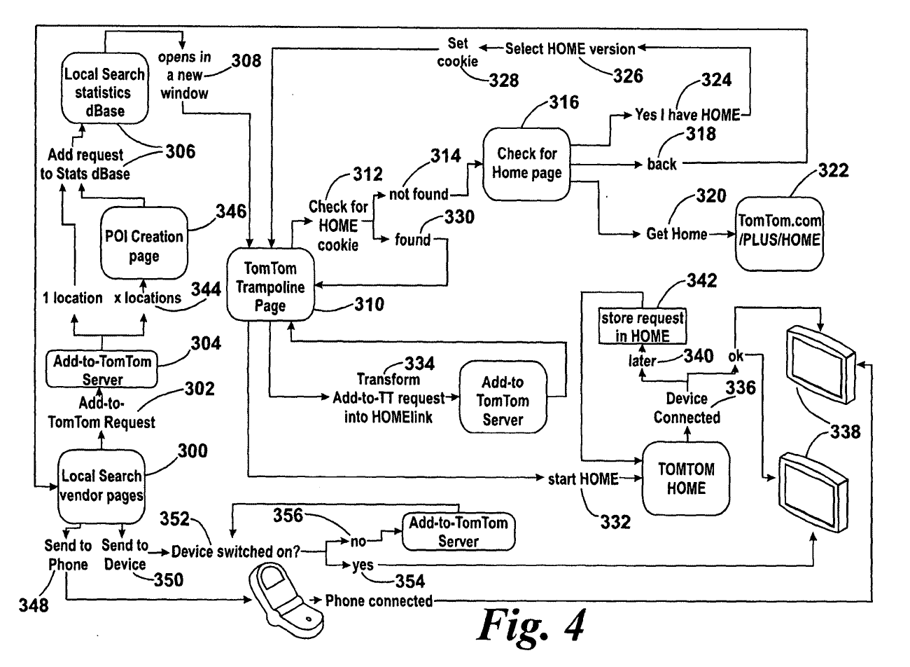

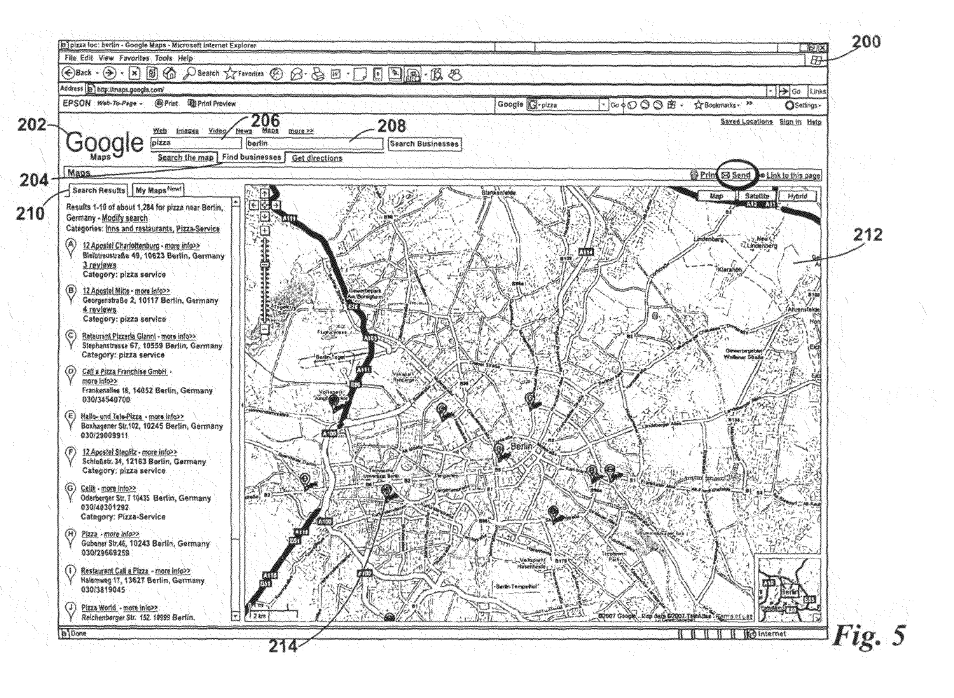

Turning to FIGS. 4 and 5, a user of the client terminal 170 wishes to import location information into the navigation device 100. In this respect, the user wishes to use location information from a source other than location information stored in a Points Of Interest (POI) database contained in the memory 120 of the navigation device 100. The user therefore firstly launches a web browser application 200, for example Internet Explorer, which is provided with the Windows™ operating system. However, the skilled person will appreciate that any other suitable browser application can be used, for example the Firefox browser distributed by the Mozilla Corporation or Opera distributed by Opera Software ASA.

The user then accesses a website 202 of a third party search provider, for example Google Maps, by typing maps.google.com into an address bar of the browser 200. In this example, the user is interested in locating a restaurant in Berlin, Germany, in particular a pizzeria, and so, after selecting a “Find businesses” tab 204 presented by the server 150 serving web pages supporting the Google Maps website, the user types the word “pizza” into a first search box 206 and the word “berlin” into a second search box 208 provided on the search page. The user is, hence, seeking Pizzerias in Berlin and these are found by the Google Maps search engine supported by the server 150. Consequently, a list of results 210 is presented (Step 300) in a first pane and a map 212 comprising markers 214 is presented in a second pane.

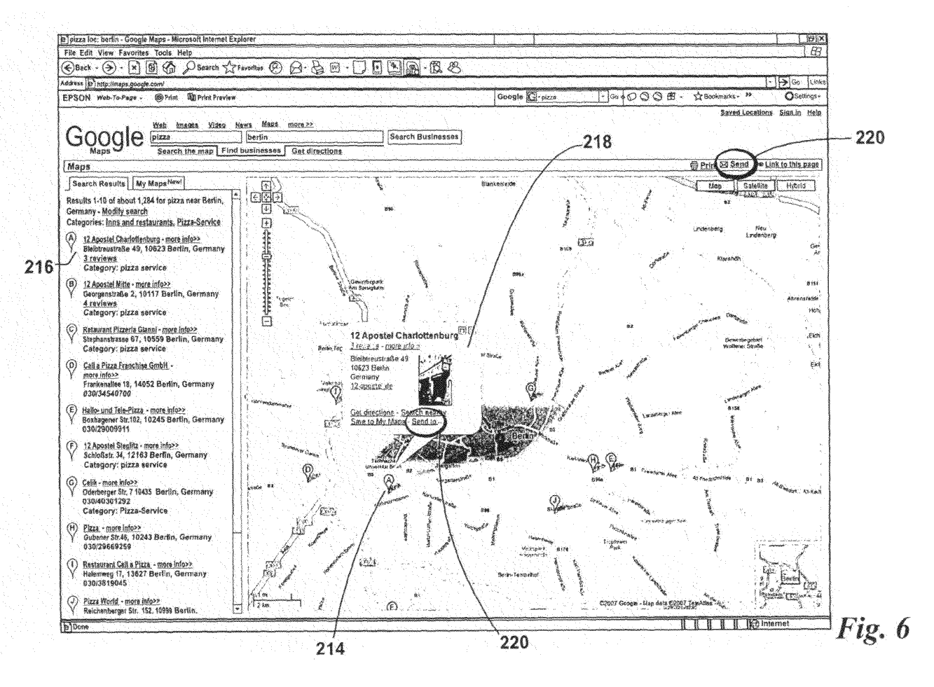

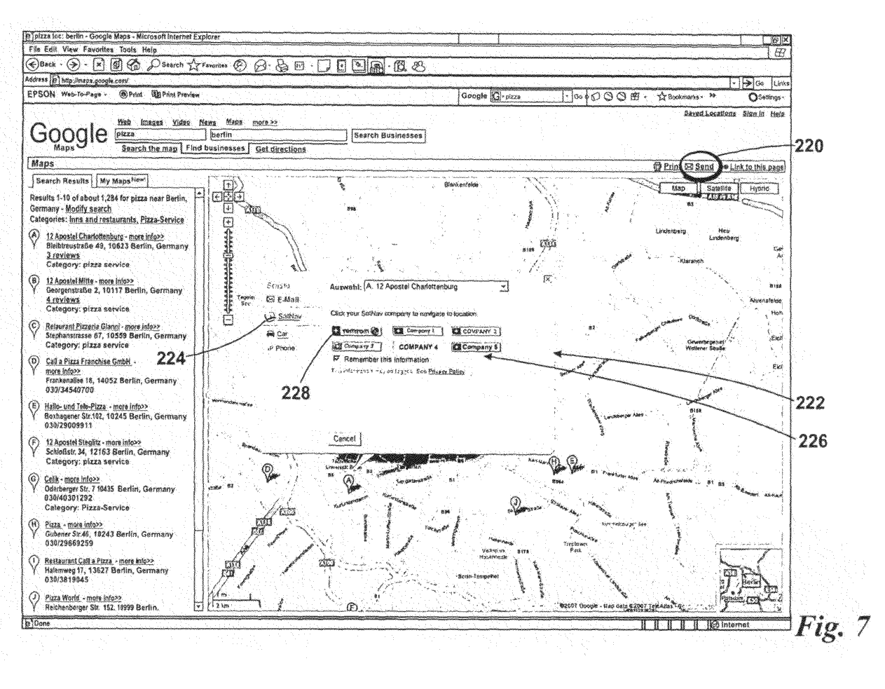

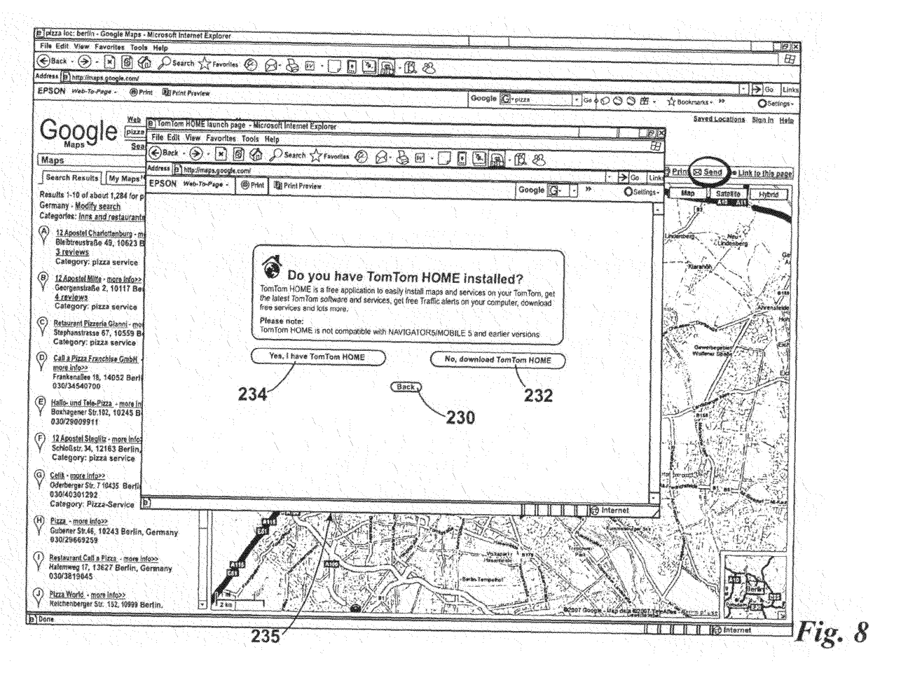

Referring to FIG. 6, the user identifies a result, in this example a restaurant, of interest 216 and is then presented with an informational bubble 218 containing brief information concerning the selected result of interest 216. Thereafter, the user selects a “Send” link 220 and is presented (FIG. 7) with “Send to . . . ” options 222, for example sent to “E-mail”, send to “SatNav” 224, send to “Car” and send to “Phone”. By selecting the SatNav option 224, the options box 222 presents send to SatNav sub-options 226 allowing the user to select a brand of navigation device (assuming the search provider, in this example Google, wishes to support more than one brand of navigation apparatus), for example TomTom. In this respect, an “Add to TomTom” button 228 is displayed in the options box 222 and is selected (Step 302), in this example, by the user.

The “Add to TomTom” icon 228 has an “Add-to-SatNav-API” address Uniform Resource Indicator (URI), sometimes referred to as a Universal Resource Locator (URL) in this context pointing to an “addto.tomtom.com” domain corresponding to the location importation data delivery server 174. Information about the selected address which the user wishes to import into the navigation device 100 is included in this URI, the URI complying with an Application Programming Interface (API) of the server 174 and organized in accordance with a first data structure definition, the definition having, in this example, the following arguments: api_key (required), action (required), name location (optional), country (required), state (optional, required for US), city (required), postcode (optional), street (required), number (optional), attribution name (optional), and attribution logo (optional). The URI forms part of a hypertext transfer protocol (HTTP) command, the HTTP being an example of a request/response communications protocol. Other possible attributes include: geo location (longitude and latitude) and content type (POI, route or voice).

For example, if the search result selected related to an address in Amsterdam, The Netherlands, the URI attached to the “Add to TomTom” button 228 can be: http://addto.tomtom.com/api/home/v1/address?action=add&api key=demoKey&country =Netherlands&city=Amsterdam&street=Rembrandtplein&number=35. By selection of the “Add to TomTom” button 228, the browser, using an HTTP GET request, communicates the request to the TomTom server 174 (Step 304).

At the TomTom server 174, the server 174 receives the request and stores the “add-to-TomTom” request in the database 178 (Step 308) for the purpose of statistical analysis. The client terminal 170 also opens a new window (Step 308) and serves a TomTom “Trampoline” or launch page (Step 310) in respect of addto.tomtom.com. Thereafter, the server 174 searches the client terminal 170 for tracking information, for example a cookie (Step 312). In this example, the cookie relates to a device management application, for example the TomTom HOME device management application distributed by TomTom International BV.

Referring to FIG. 8, if the server 174 is, following the search, unable to find for the TomTom HOME Cookie (Step 314), the server 174 serves a “Check for HOME” page (Step 316) displayed in the new window 235. In the “Check for HOME” page, a “Back” button 230, “No, download TomTom HOME” button 232 and a “Yes, I have TomTom HOME” button 234 are presented. If the user selects the “Back” button 230 (Step 318), the new window 235 closes and the “Check for HOME” page and the “TomTom Trampoline” page are no longer presented, leaving the user back at the search result page of the third party search provider. If the user selects the “No, download TomTom HOME” button 232 (Step 320), the user is re-directed to a www.tomtom.com/PLUS/HOME page (Step 322) in the new window 235 where more information about the TomTom HOME device management application can be found and a copy of the device management application can be downloaded by the user and installed. Alternatively, if the user selects the “Yes, I have TomTom HOME” button 234 (Step 324), the server 174 will display a page (not shown) allowing the user to select a version of HOME installed (Step 326) on the client terminal 170, for example by selecting an image of the user interface of the version of the device management application installed, and the server 174 then sets (Step 328) an appropriate TomTom HOME Cookie. Thereafter, the TomTom “Trampoline” page is displayed again (Step 310) and the check for the TomTom HOME Cookie is repeated (Step 312) as described above.

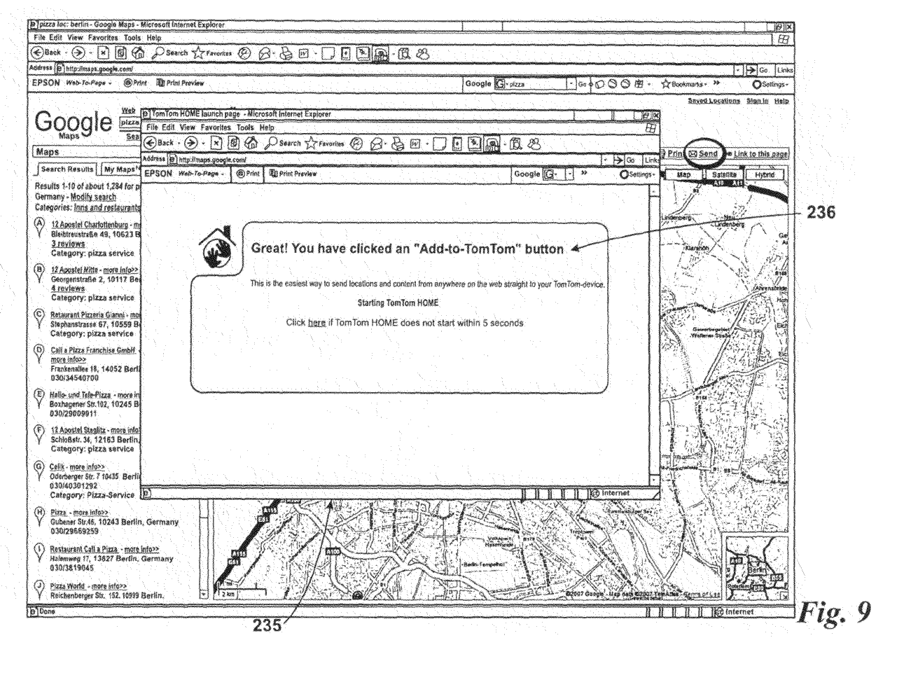

However, as the device management application has now been identified (Step 330) as installed on the client terminal 170, the new window 235 contains a confirmatory message 236 (FIG. 9). If a name and/or logo of an attribution partner of the third party local search partner is included in the URL of the “Add to TomTom” button 228, the name and/or logo can be displayed in the confirmatory message. An attribution name is a name of a third party from where location information, for example an address, originates. The device management application is then launched (Step 332).

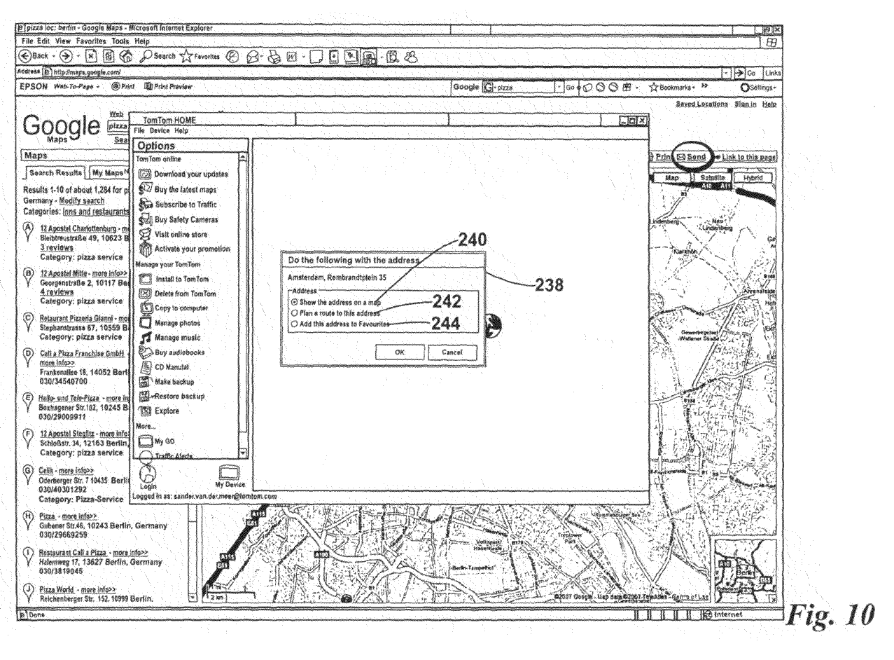

The server 174 then converts (Step 334) the request associated with the “Add to TomTom” button 228 to an “address-URL” or device URI specific to the version of the TomTom HOME device management application that is installed on the client terminal 170, and the address-URL is then sent to the browser 200 by the server 174. In this example, the device URI is organized in accordance with a second data structure definition and includes a command. The device URI is received by the device management application and depending on the type of address command contained in the device URI sent by the server 174, the device management application either shows the address on a map, plans a route to the address, or adds the address to Favourites. In respect of the latter course of action, if no location name is included in the “Add to TomTom” URI and hence the device URI, the device management application prompts the user to enter a name. Alternatively, the device management application responds to the device URI received by displaying an options box 238 (FIG. 10) permitting the user to select between operational functions of a navigation device, for example navigation-related operations of showing the geographic location on a map 240 and planning a route to the address 242, or other functions, for example adding the address to the “Favourites” locations 244 stored by the navigation device 100. Other operational functions include sending via SMS, show on an online map, call location, send to a friend, store at account, and/or correct or enrich location.

The device management application then checks (Step 336) to determine if the navigation device 100 is connected and, if not, the user is prompt to connect the navigation device 100 to the client terminal 170 via the USB port thereof. The request contained in the device URI is then sent to the navigation device 100 and executed (Step 338). Alternatively, if the user is unable or unwilling to connect the navigation device 100 to the client terminal 170, the device management application allows the user to defer (Step 340) importation into the navigation device 100 to the client terminal 170 and queues or buffers (Step 342) the request and performs the request when the navigation device 100 is next connected to the client terminal 170. In the event that multiple events or requests are queued, the device management application sends the multiple events to the navigation device 100 in concatenated form.

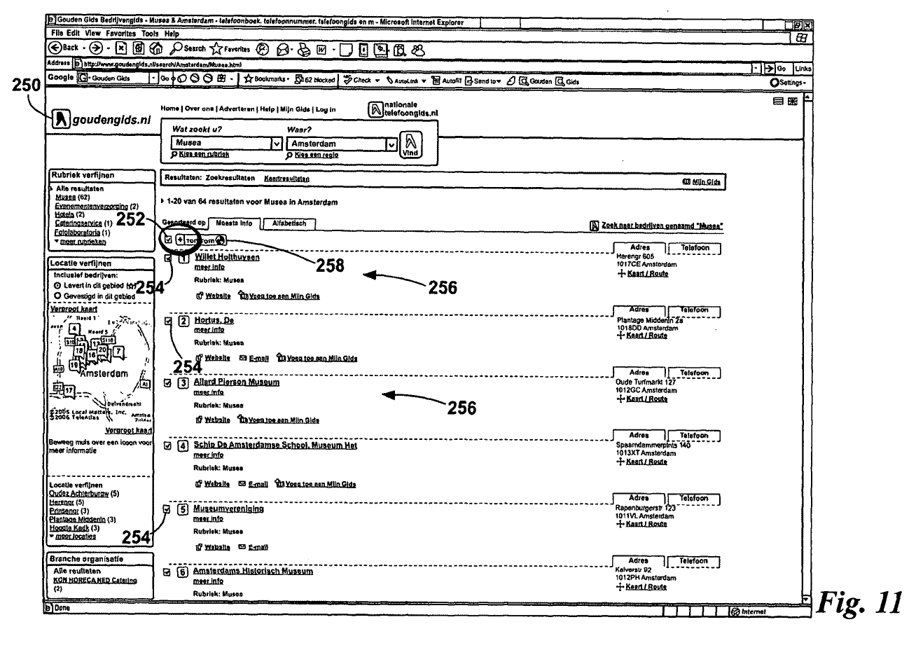

In another embodiment, the user performs a search on another third party local search website (Step 300), in this example “goudengids.nl”, a Dutch-language version of the English-language Yellow Pages website 250 (FIG. 11). The search website yields search results that the user evaluates. In this example, the user is seeking museums in Amsterdam, The Netherlands.

In this example, the website 250 provides a “select all” check box 252 as well as individual check boxes 254 to allow the user to select multiple individual result entries 256 and an “Add to TomTom” button 258 to action importation of the multiple result entries selected. In this respect, the “Add to TomTom” button 258 contains an “Add-to-SatNav-API” multiple address command, which is generated in response to selection (Step 302, 304) of the “Add to TomTom” button 258. The URI generated by the server 170, including location data corresponding to the selected results entries 256, points to the addto.tomtom.com domain corresponding to the server 274. Selection of the “Add to TomTom” button 258 results in the server 274 determining (Step 344) that multiple locations have been selected and serving a POI creation page 346 to allow the user to manage creation of a set of POIs, including customizing the name of the POI set (by default the name of the local search partner and a brief of the search query) and/or an icon for the POI set (by default the icon of the local search partner and the icons of sponsored locations, if any). Once the user has finished creating the set of POIs, the server 174 stores the “Add to TomTom” request relating to the set of POIs in the database 178 (Step 306) for the purpose of analysis and the above-mentioned process is performed in relation to launching the device management application and ensuring (if possible) that the navigation device 100 is connected to the client terminal 170. The statistical analysis can be performed in order to monitor for popular trends, for example popularity of specific addresses, address genres, for example restaurants, and popularity of specific addresses sent by a specific vendor.

In this example, the set of POIs data is generated as an XML file. After the URI has been received and the set of POIs has been generated, the server 174 generates a device URI that is sent to the device management application. The device management application responds to the device URI, constituting an “Install link”, by importing the set of POIs from the server 174 into the navigation device 100 in an analogous manner to that described above in relation to importing a single address.

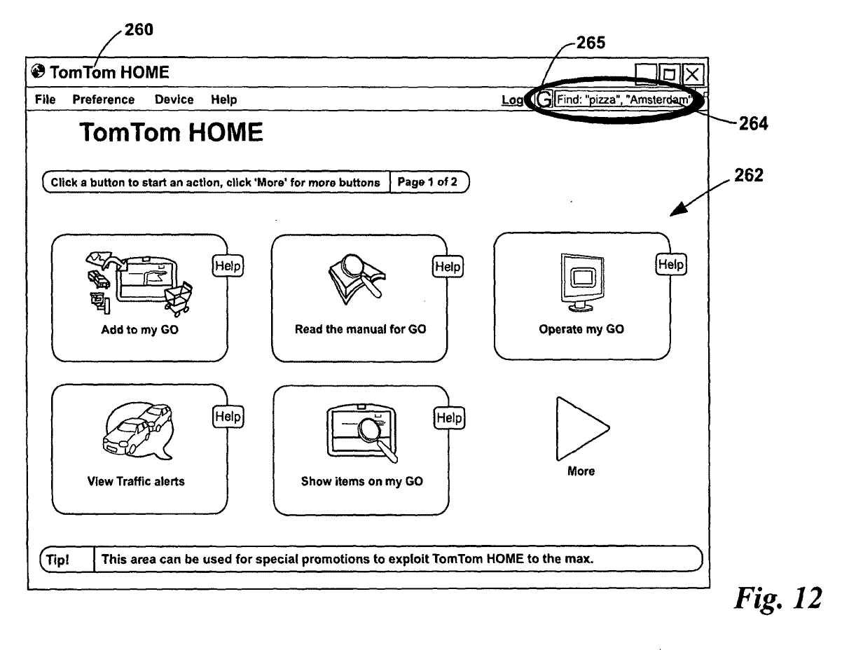

In another embodiment, the device management application 260 (FIG. 12) communicates with the server 150 directly in order to communicate search queries and receive results instead of via the browser 200 described in the previous embodiments. In this respect, a main menu 262 of the device management application 260 comprises a quick search box 265, for experienced users, where the user can type search terms. A logo 266 next to the search box 264 indicates the local search partner being used and selection of the logo 265 of the local search partner reveals a drop down list of alternative local search partners (not shown). If desired, in a preference menu of the TomTom HOME device management application 260, a preferred local search partner can be set. Additionally, plug-ins can be used to add further partners.

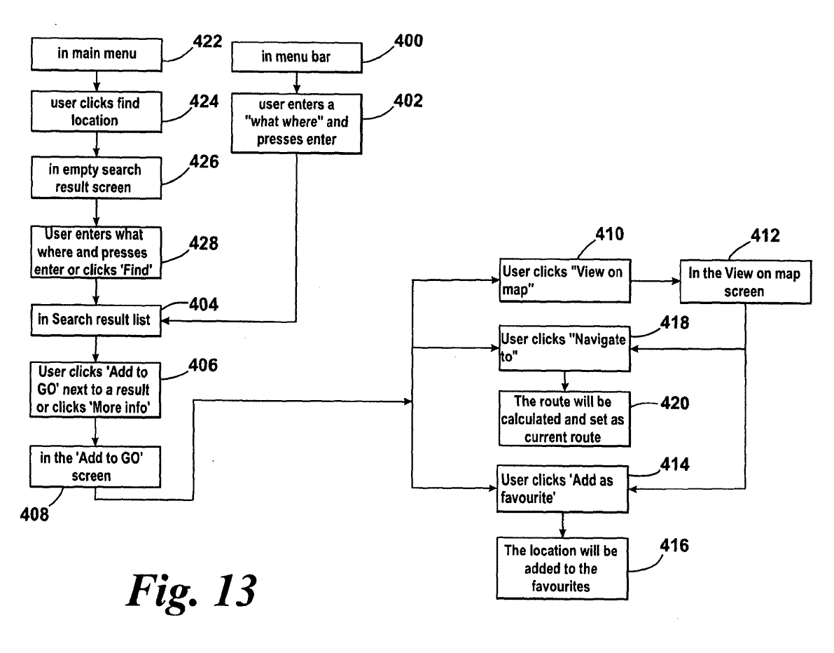

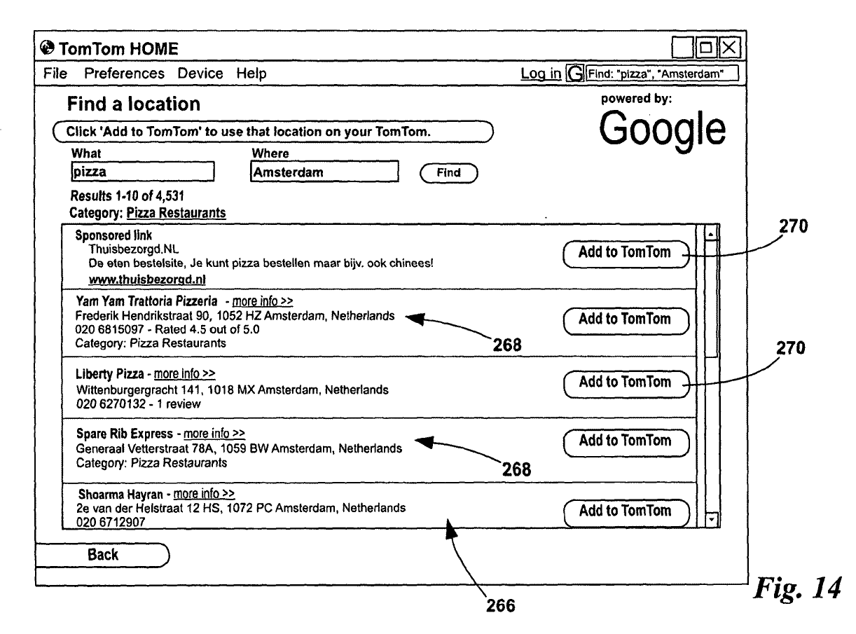

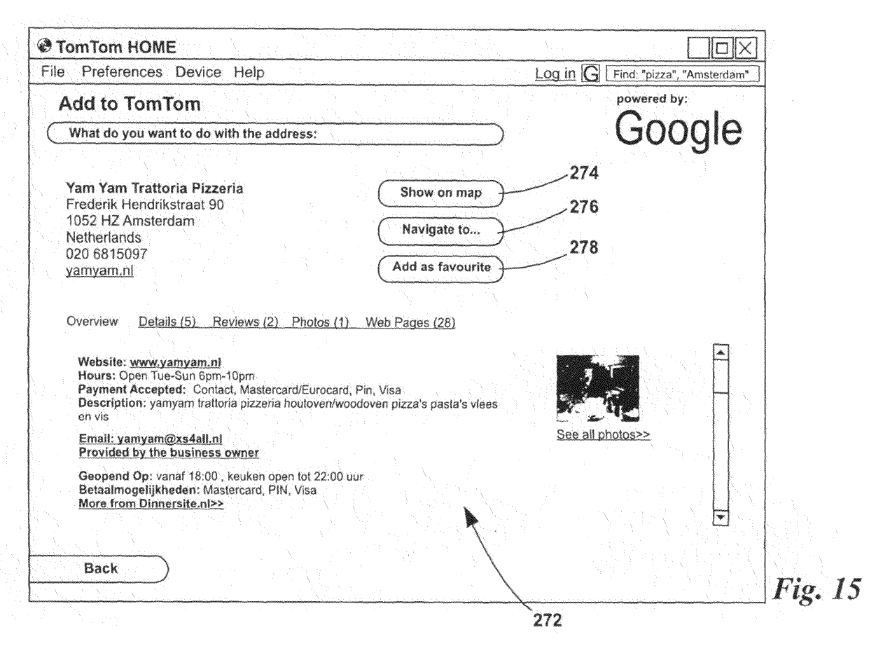

Referring to FIG. 13, starting at the main menu 262 (Step 400) of the device management application 260, the user types the search terms into the quick search box 264 (Step 402) constituting a search query, indicative of nature (“what”) and location (“where”), for example “pizza”, “London” or “pizza”, “Amsterdam”. The user can, of course, include any number of additional search terms in order to further confine the search. The user then “hits return” and the device management application 260, using the API for the local search provider, sends a content request in accordance with the HTTP to the server 150 of the search provider. The search results are then returned by the server 150 and displayed in a results panel 266 (Step 404) of the device management application 260 (FIG. 14). Basic information for each address found is displayed in the results panel 266, each results entry 268 having an “Add to TomTom” button 270 next to it. Referring to FIG. 15, if the user “clicks” (Step 406) on one of the “Add to TomTom” buttons 270 associated with a result entry of interest, more information 272 (if available) is displayed concerning the location selected (Step 408) as well as various options to use the location information in relation to navigation, for example a “Show on map” button 274, a “Navigate to . . . ” button 276 and a “Add to favourite” button 278. In response to selection of one of the options 274, 276, 278, the device management application 260 checks that the navigation device 100 is connected to the client terminal 170 and, if not, prompts the user to connect the navigation device 100. If the user is unable or unwilling to connect the navigation device 100 to the client terminal 170, then the device management application 260 queues or buffers the request made by the user so as to defer implementation of the request, the request being sent to the navigation device 100 the next time the navigation device 100 is connected to the client terminal 170. Multiple events, as will be described later below, are queued and sent to the navigation device 100 concatenated in a like manner to that already described above in relation to the previous embodiments.

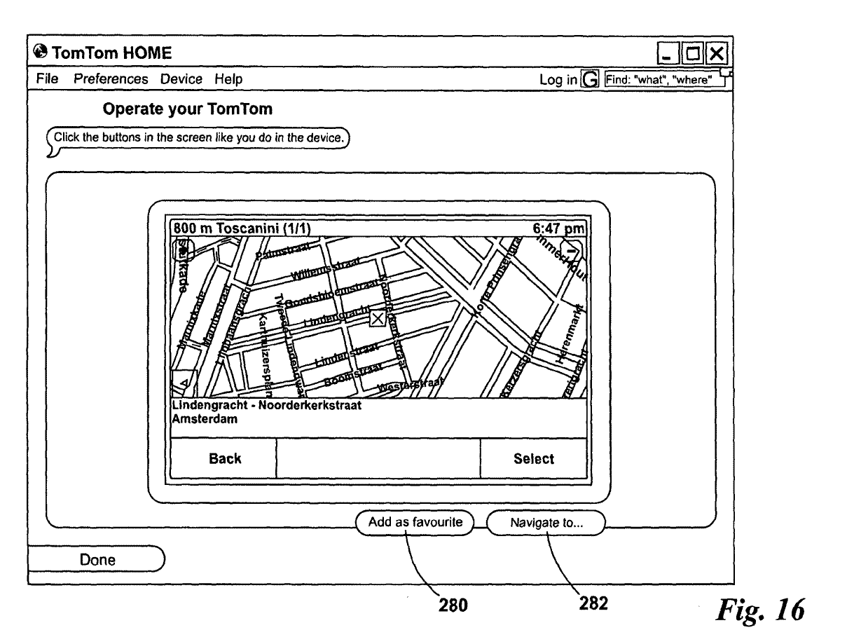

In the event that the navigation device 100 is connected to the client terminal 170, the request made by the user is executed. In a first example, if the user has selected the “Show on map” button 274 (Step 410), the device management application 260 launches a device operation sub-application (FIG. 16) and displays (Step 412) the selected location on a map.

From the device operation sub-application, another “Add to favourite” button 280 and another “Navigate to . . . ” button 282 are displayed that enable the user to make the same remaining selections as provided when more information 272 was being displayed in the previous screen presented by the device management application 260. In this respect, selection (Step 414) of the “Add to favourite” button 278 or the another “Add to favourite” button 280 results in the device management application 260 using the location data obtained in order to add (Step 416) the location data to the favourite locations stored by the navigation device 100. Similarly, selection (Step 418) of the “navigate to . . . ” button 276 or the another “Navigate to . . . ” button 282 results in the device management application 260 using the location data obtained in order to calculate a route (Step 420) to a location corresponding to the location data selected.

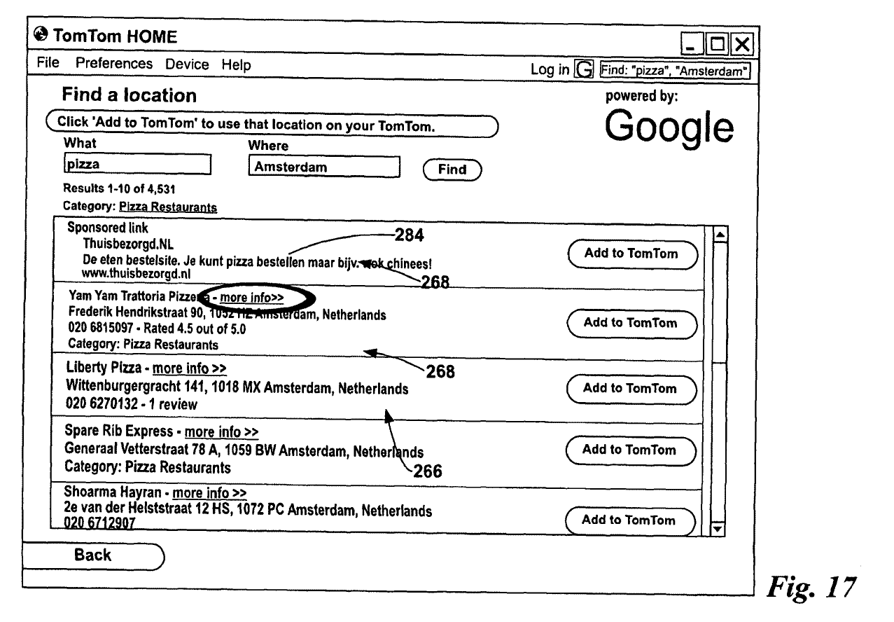

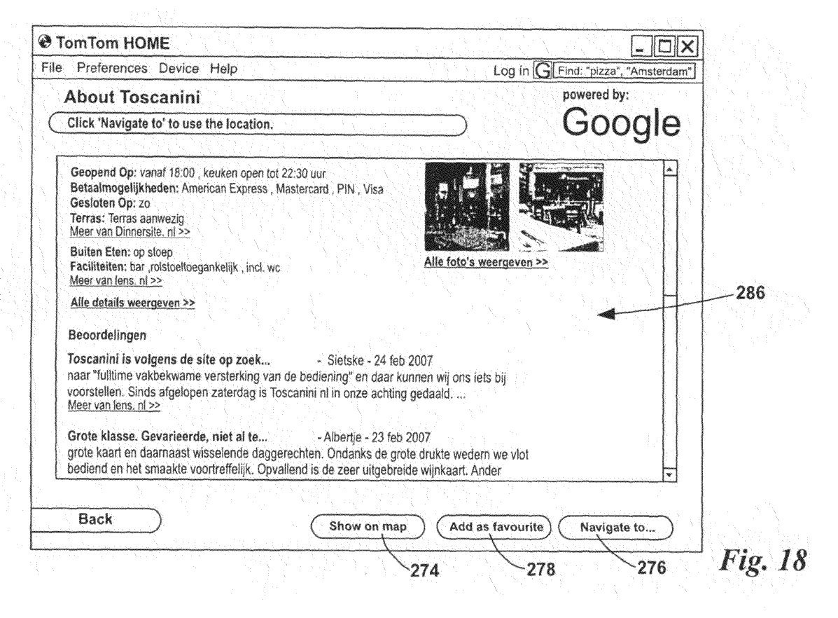

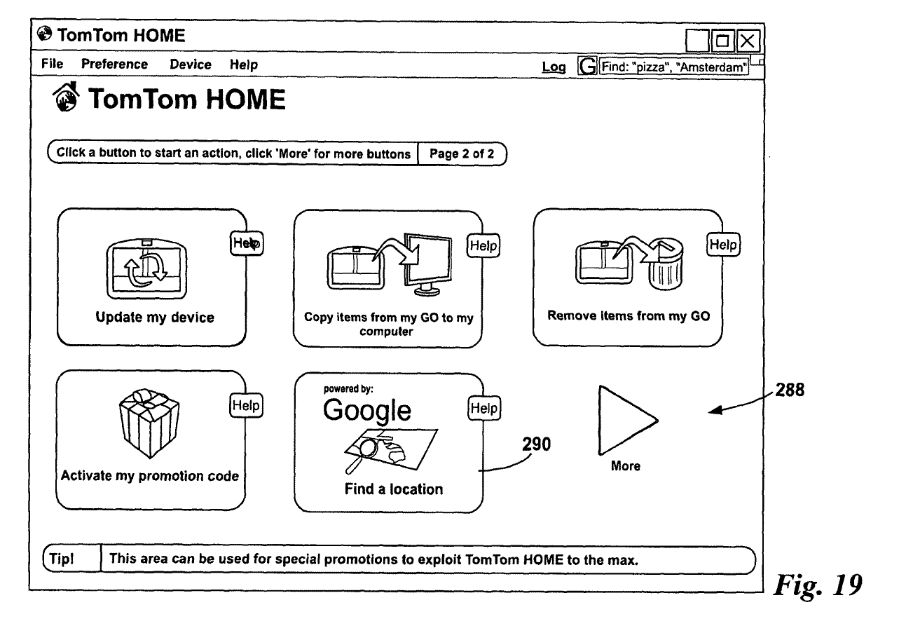

In a further embodiment (FIG. 17), the results panel 266 comprises one or more “more info” links 284 for the provision of additional information in relation to associated result entries 268. Selection of one of the “more info” links 284 results in the device management application 260 displaying a screen 286 displaying containing the rich information (more detail) concerning the location selected and available from the search partner. Again, the navigation options 274, 276, 278 mentioned above are provided in the rich information screen 286.

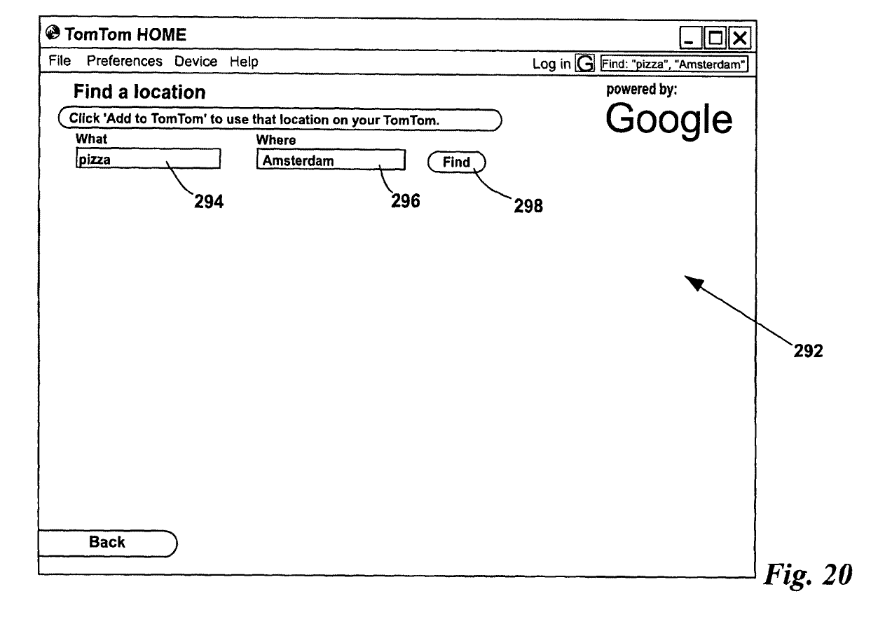

In yet another embodiment, the device management application 260 is operated from the main menu (Step 422), in particular a second screen 288 of the main menu 262 as an alternative to using the quick search box 264. In this respect, the second screen 288 of the main menu 262 comprises a “Find a location” button 290 that the user selects (Step 424). Selection of the “Find a location” button 290 results in the device management application 260 displaying (Step 426) a search query screen 292 (FIG. 20) having a form-like structure including a first data entry box 294 for specifying a nature of what is sought (“what”) and a second data entry box 296 for specifying a location (“where”), for example “pizza”, “London” or “pizza”, “Amsterdam” as described above in relation to a previous embodiment. This information is typed (Step 428) into the first and second data entry boxes 294, 296 and the user then “clicks” on a “Find” button 298 adjacent the first and second data entry boxes 294, 296. The device management application 260 then, using the API for the local search provider, sends a content request to the server 150 of the search provider. As one would expect, following processing by the server 150, the search results are then returned by the server 150 and displayed in the results panel 266 (Step 404) of the device management application 260 (FIG. 14) in a like manner to that already described above in relation to the previous embodiment involving the quick search box 264. Thereafter, operation of the device management application 260 is as described above in relation to the previous embodiment involving the quick search box 264 and so for the sake of conciseness and clarity of description will not be describe in further detail herein.

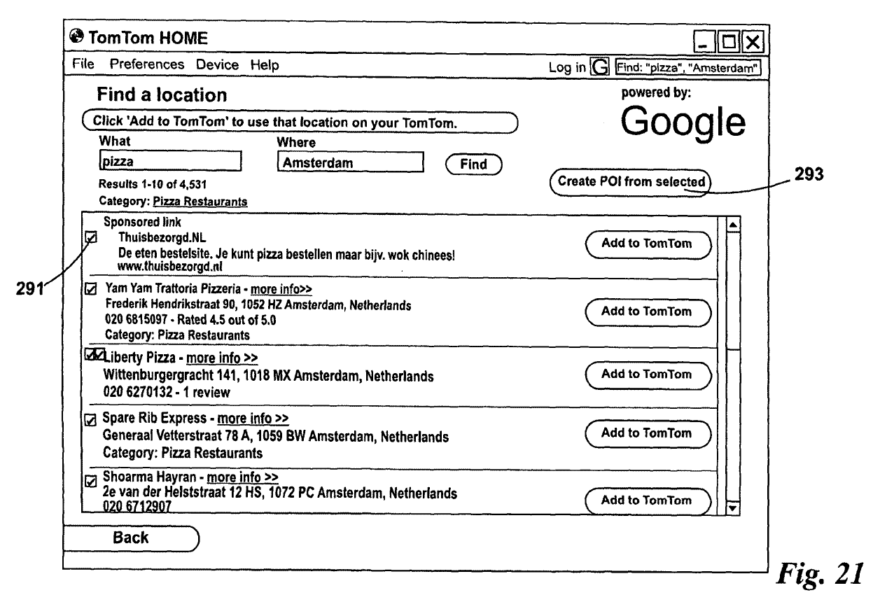

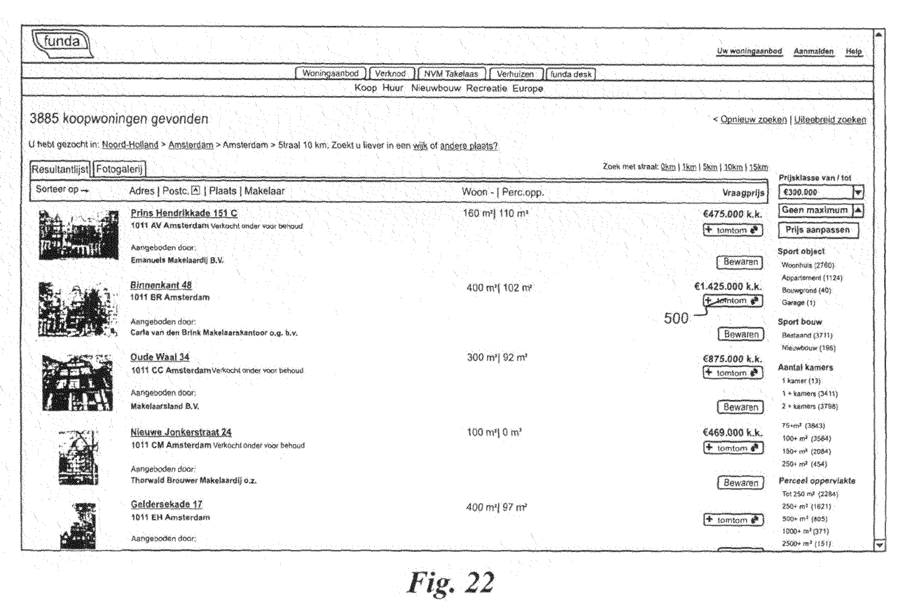

In a further embodiment (FIG. 21), when the results panel 266 is displayed by the device management application 260, the device management application 260 supports selection of multiple locations in order to create a set of POIs. In this respect, the user interface of the device management application 260 provides individual check boxes 291 respectively adjacent each results entry 268 as well as, optionally, a “Select all” button or check box (not shown). A “Create POI from selected” button 293 is displayed in the results screen 266, selection of the “Create POI from selected” button 293 results in the device management application 260 displaying a special customization screen providing customization options, the availability and extent of such options depending upon what is permitted by the third party local search partner. In one example, the customization screen allows the user to name a POI set (by default the name of the local search partner and a brief of the search query) and/or select one or more icons for the POI set (by default the icon of the local search partner and the icons of sponsored locations, if any). The customization screen can also allow the user to select whether the POI set to be created should include rich information (more detail).

In another embodiment, where in any of the above-described embodiments, the navigation device 100 is not connected to the client terminal 170, the server 150, through the browser 200 or the device management application 260, provides the user with an option to send the location data directly to the navigation device 100 Over-The-Air (OTA) (Steps 348, 350). In one example, the navigation device 100 is capable of wirelessly communicating with a “bonded” communications apparatus, for example a wireless communications device, such as a cellular telephone. Assuming the wireless communications device is contactable, the server 150 sends the location information requested to the wireless communications device for communication to the navigation device 100 and subsequent importation into the navigation device 100. In this respect, the location data is communicated by the server 150 to any suitable data transmission gateway to communicate the location data to the navigation device 100, the location data being organized in accordance with a suitable data structure definition to permit communication with the navigation device 100 wirelessly.

In another example, the navigation device 100 is provided with an internal wireless data communications device and has a subscription associated therewith. The server 150 initially tries to establish (Step 352) if communication with the navigation device 100 is possible over a wireless communications network, for example when the navigation device 100 is able to receive data and enjoy a sufficient degree of reception. If the navigation device 100 is able to receive data when the server 150 wishes to send the location data, the location importation data is sent (Step 354) directly to the navigation device 100 for importation thereby. Alternatively, if connectivity with the navigation device 100 is not possible (Step 356), the server 150 sends the location importation data to the server 174 for buffering. When the navigation device 100 subsequently returns to a state of connectivity, the navigation device 100 downloads the location importation data from the server 174 or the data is “pushed” by the server 174 for subsequent importation by the navigation device 100.

In a further embodiment, the navigation device 100 is again provided with an internal wireless data communications device and has a subscription associated therewith as mentioned above. Of course, the skilled person will appreciate that a bonded wireless communications device can similarly be employed if the navigation device 100 does not posses the internal wireless communications device and associated Subscriber Identity Module (SIM). In this respect, the application software of the navigation device 100 is arranged so that it is capable of communicating search requests to the server 150 and wirelessly receiving the results of the search request. To this end, the user interface of the application software comprises additional screens to allow the user to enter search queries and handle communication of the query and the search results wirelessly.

Using the application software 136, the user is able to search for addresses using the user interface of the application software 136, the application software 136 being able to operate in accordance with the API of the search service provider associated with the server 150. The navigation device 100 is arranged to use the results of the search query received from the server 150 seamlessly, tapping into all the appropriate features of the application software 136, for example “add to favourites” or “navigate to”. Additionally, in this example, the application software 136 provides the user with a facility to select multiple locations from the search results received and to create a POI set from the selected results, the user being able to install the POI set into the navigation device 100.

In yet a further embodiment, a plug-in, constituting a location data processing apparatus, is provided for the web browser 200 of the first embodiment described above. The plug-in comprises a data enrichment module 171 that, when installed, scans content received from the server 150 for candidate location information, for example addresses. When candidate location information is recognized, the plug-in extracts data from the candidate location information corresponding to fields of a data structure definition of the location importation data, the data structure definition being analogous to that described above in relation to previous embodiments. The data extracted is organized in accordance with the data structure definition. The plug-in then enriches the content received by incorporating (optionally) an object, for example an “Add to TomTom” button 500. The object 500 is associated with the location importation data, for example a request in the form of an HTTP GET request that points to the server 174, the request comprising a URI: either pointing to the server 174 or a device URI of the type described in previous embodiments for direct importation. The choice of type of URI to employ depends upon whether or not the server 174 is being employed. The object and the location data are embedded by the plug-in so that the object appears beneath, adjacent or opposite the address data and so can be visually recognized as associated with the address data.

In this example, the plug-in is of an auto-crawler type that therefore scans web pages that the user visits and tries to recognise standard address formats in the content downloaded on-the-fly and embeds the “Add to TomTom” button 500 and associated link to the server 174. Examples of standard address formats include, but are not limited to: HTML card (H-card), Keyhole Markup Language (KML) and GeoRSS). In another example, the plug-in can optionally provide the user with an ability to identify address data, for example using the mouse of the client terminal 170, and select the address data for the plug-in to process in order to generate the object and/or associated location data.

The location importation data can be ready for use by the device management application 260 for direct importation. Alternatively, the location importation data can comprise a selectable HTTP request for the server 174 to convert the location importation data into a form compatible with direct importation.

Processed location information received from the server 174 can then be used by the device management application 260 in the manner described above in relation to operation of the navigation device 100, for example in relation to the “add to favourite”, the “navigate to” and the “show in map” functions described above.

The plug-in can be downloaded from, for example, a website of a manufacturer of the navigation device 100 or via the device management application 260, when the device management application 260 checks for updates, such as when a user upgrades. Similarly, when the device management application 260 is being installed afresh, the user is then prompted by the device management application 260 and provided with an option to install the plug-in. Although not specifically stated above, it should be appreciated that location data processing apparatus can be provided in other embodiments described above in order to avoid the server 150 generating location importation data conforming to the first data structure definition or where the server 150 is unable to generate such data. Similarly, in some instances, it may be desirable to avoid generation by the server 174 of the location importation data conforming to the second data structure definition. In this respect, the data enrichment module can be implemented in the device management application and/or the navigation apparatus 100.

Hence, it can be seen from the above examples that location importation data can be served to a client terminal or generated locally at the client terminal, the client terminal being any suitable computing apparatus, for example the client terminal supporting the device management application or the navigation device. As employed in the above embodiments, the location importation data can be generated in a first form conforming to the first data structure definition and a second form conforming to the second data structure definition. In this respect, the first form can be generated by the server 150 or locally so subsequent use to obtain a conversion of at least part of the location importation data into an importable form, namely the second form, can be achieved. As an alternative to serving the location importation data, the location importation data can be generated by the location data processing apparatus locally in the second form in conjunction with the browser of the client terminal, the device management application or the application software of the navigation device.

The location importation data of the second form can be used by the navigation device directly or by the device management application directly in order to import location data into the navigation device.

Whilst the use of HTTP as the request/response communications protocol has been described herein, the skilled person should appreciate that a File Transfer Protocol (FTP) can be employed if it is expedient to do so. Also, the above configurations can be used to block receipt of location information from specific authors.

The above techniques can be used as part of a shared revenue scheme in order to share, for example, advertising revenue between providers of data, for example providers of search engine services or the like, and manufacturers of navigation equipment, for example the navigation device 100 and/or a party providing the service of the location data delivery server 174. Additionally, third parties providing the data retrieval services, for example search services, or third parties associated with the location importation data can be provided with greater visibility on the navigation device 100, for example by display of logos and/or rich information, in exchange for payment. This facility can be provided by the provider of the data retrieval service to advertisers and an additional fee can be charged in respect of the facility provided to advertisers, thereby providing greater scope for revenue sharing.

It will also be appreciated that whilst various aspects and embodiments of the present invention have heretofore been described, the scope of the present invention is not limited to the particular arrangements set out herein and instead extends to encompass all arrangements, and modifications and alterations thereto, which fall within the scope of the appended claims.

For example, although the above embodiments have been described in relation to the server 150 supporting the search engine service, the skilled person should appreciate that this is a simplification for the sake of conciseness and clarity of description and any suitable hardware and/or software configuration can be implemented to support the search engine service.

Whilst embodiments described in the foregoing detailed description refer to GPS, it should be noted that the navigation device may utilise any kind of position sensing technology as an alternative to (or indeed in addition to) GPS. For example the navigation device may utilise using other global navigation satellite systems such as the European Galileo system. Equally, it is not limited to satellite based but could readily function using ground based beacons or any other kind of system that enables the device to determine its geographic location.

Alternative embodiments of the invention can be implemented as a computer program product for use with a computer system, the computer program product being, for example, a series of computer instructions stored on a tangible data recording medium, such as a diskette, CD-ROM, ROM, or fixed disk, or embodied in a computer data signal, the signal being transmitted over a tangible medium or a wireless medium, for example, microwave or infrared. The series of computer instructions can constitute all or part of the functionality described above, and can also be stored in any memory device, volatile or non-volatile, such as semiconductor, magnetic, optical or other memory device.

It will also be well understood by persons of ordinary skill in the art that whilst the preferred embodiment implements certain functionality by means of software, that functionality could equally be implemented solely in hardware (for example by means of one or more ASICs (application specific integrated circuit)) or indeed by a mix of hardware and software. As such, the scope of the present invention should not be interpreted as being limited only to being implemented in software.

Lastly, it should also be noted that whilst the accompanying claims set out particular combinations of features described herein, the scope of the present invention is not limited to the particular combinations hereafter claimed, but instead extends to encompass any combination of features or embodiments herein disclosed irrespective of whether or not that particular combination has been specifically enumerated in the accompanying claims at this time.

1. A location data processing apparatus comprising: a data enrichment module arranged to receive, when in use, content generated in response to a content request; wherein the data enrichment module is arranged to embed location importation data in the content prior to presentation thereof, the location importation data being organized in accordance with a data structure definition.

2. An apparatus as claimed in claim 1, wherein the data enrichment module is arranged to analyze the content and identify candidate location information therein, the data enrichment module being further arranged to generate the location importation data from the candidate location information.

3. An apparatus as claimed in claim 2, wherein the data enrichment module is arranged to extract data from the candidate location information, the data corresponding to a number of fields of the data structure definition, and organize the extracted data in accordance with the data structure definition.

4. An apparatus as claimed in claim 1, wherein at least part of the location importation data is encoded as a Uniform Resource Indicator (URI).

5. An apparatus as claimed in claim 1, wherein the data structure definition conforms to an Application Programming Interface (API) of a server.

6. An apparatus as claimed in claim 1, wherein the data enrichment module is arranged to embed an object in the content associated with the location importation data, the object providing a visual indication of an existence of location information importable into a navigation apparatus and associated with a geographic location shown in the content.

7. An apparatus as claimed in claim 1, wherein the location importation data is compatible with an import process of at least one of a device management application and a navigation apparatus.

8. An apparatus as claimed in claim 1, wherein the location importation data comprises a request in accordance with a request/response communications protocol.

9. A client terminal apparatus comprising: a processing resource arranged to support the location data processing apparatus as claimed in any one of the preceding claims; and a communications interface for communicating the content request to a content server; wherein the processing resource is arranged to support a user interface for receiving information relating to the content request.

10. An apparatus as claimed in claim 9, further comprising: a browser application supported by the user interface for providing a data collection interface for collecting the information relating to the content request; wherein the browser application is arranged to present the content received as modified by the data enrichment module.

11. An apparatus as claimed in claim 9, wherein the data enrichment module is a browser plug-in.

12. An apparatus as claimed in claim 10, wherein the data enrichment module is arranged to receive identification information via an input device, the identification information identifying at least part of the content received and relating to a geographic location, the data enrichment module being arranged to generate the location importation data in respect of the part of the content received and in response to the provision of the identification information.

13. An apparatus as claimed in claim 9, further comprising: a device management application for managing an externally connectable navigation device, the device management application being arranged to provide, when in use, a data collection interface for collecting the information relating to the content request; wherein the device management application is arranged to present the content received as modified by the data enrichment module.

14. An apparatus as claimed in claim 13, wherein the device management application is arranged to determine whether a navigation device is coupled to the client terminal apparatus.

15. An apparatus as claimed in claim 14, wherein the device management application is arranged to import at least part of the location importation data into the navigation device in response to the navigation device being detected as coupled to the client terminal apparatus.

16. An apparatus as claimed in claim 14, wherein the device management application is arranged to queue the at least part of the location importation data for subsequent importation into the navigation device in response to the navigation device being detected as disconnected from the client terminal apparatus.

17. An apparatus as claim 9, further comprising: a navigation application of a navigation apparatus, the navigation application being arranged to provide, when in use, a data collection interface for collecting the information relating to the content request; wherein the navigation application is arranged to present the content received as modified by the data enrichment module.

18. An apparatus as claimed in claim 9, wherein the processing resource is arranged, via the user interface, to present a plurality of geographic locations and to permit a user to select more than one of the plurality of geographic locations to provide an indication of a set of points of interest.

19. An apparatus as claimed in claim 9, wherein the location importation data identifies a server for converting the location importation data into an importable format organized in accordance with another data structure definition that can be used by the client terminal apparatus for importation.

20. An apparatus as claimed in claim 19, wherein the processing resource is arranged to communicate the selected more than one of the plurality of geographic locations to the server for processing and subsequent receipt of the location importation data corresponding to the set of points of interest.

21. An apparatus as claimed in claim 19, wherein location importation data is arranged so that a browser application opens a launch page in response to selection of the location importation data.

22. An apparatus as claimed in claim 9, wherein the processing resource is arranged to communicate a request to a server in response to user-selection of the location importation data, the request being indicative of a request for wireless communication of information corresponding to at least part of the location importation data from the server to a navigation apparatus for importation into the navigation apparatus.

23. A method of importing location information into a navigation apparatus, the method comprising:
communicating a request for content from a client terminal to a server;
accessing and processing data in order to service the request for content, the content comprising candidate location information corresponding to a geographic location;
generating location importation data relating to the candidate location information, the location data being organized in accordance with a data structure definition; and
embedding the location importation data in the content.

24. A computer program element comprising computer program code segments to make a computer execute the method as claimed in claim 23.

25. A computer program element as claimed in claim 24, embodied on a computer readable medium.

26. An apparatus as claimed in claim 11, wherein the data enrichment module is arranged to receive identification information via an input device, the identification information identifying at least part of the content received and relating to a geographic location, the data enrichment module being arranged to generate the location importation data in respect of the part of the content received.

27. An apparatus as claimed in claim 1, wherein the location importation data identifies a server for converting the location importation data into an importable format organized in accordance with another data structure definition that can be used by the client terminal apparatus for importation.

28. A computer readable medium including program segments for, when executed on a computer device, causing the computer device to implement the method of claim 23.
